(19) United States
(12) Patent Application Publication
(10) Pub. No.: US 2025/0360448 A1
(43) Pub. Date: Nov. 27, 2025

(54) AIR PURIFIER FOR DECOMPOSING SMOKE THROUGH WATER FILTRATION

(71) Applicants: Liming HUANG, NEW YORK, NY (US); Shenzhen Blue Whale Future Technology Co., Ltd, SHENZHEN (CN); Shenzhen Great Dragon Technology Co,LTD, SHENZHEN (CN)

(72) Inventors: HANBING DU, SHENZHEN (CN); JIFU TANG, GUILIN (CN); LIMING HUANG, NEW YORK, NY (US)

(21) Appl. No.: 18/671,918

(22) Filed: May 22, 2024

(51) Int. Cl. B01D 47/02

(52) U.S. Cl. CPC B01D 47/02

(57) ABSTRACT

The present invention discloses an air purifier for decomposing smoke through water filtration, including a collection cover, an air inlet pipe, a purifier and an exhaust pipe, where the collection cover is provided with the air inlet pipe on its front top, another end of the air inlet pipe is connected with the purifier, and the purifier is connected with the collection cover through the exhaust pipe connected by a screw on its rear left top to form a circulating flow of air. Through internal circulation, dual-effect physical adsorption and chemical decomposition, the purifier in the present invention alleviates problems of a conventional filtration method using a HEPA filter, for example, a low cleansing speed, an unsatisfactory effect and regular replacement caused due to likeliness to clog, and can also reduce noise with the help of the collection cover and have characteristics of easy installation and a good sealing effect.

### TECHNICAL FIELD

The present invention relates to an air purifier, and in particular, to an air purifier for decomposing smoke through water filtration.

### TECHNICAL BACKGROUND

In modern society, desktop laser processing devices are developing rapidly, and are widely used for processing various materials, including fabric, metal, wood, leather, acrylic, and the like. In addition, these laser devices generate a large amount of harmful gases such as smoke, formaldehyde and carbon monoxide during the processing, and a conventional filtration method using a HEPA filter has problems, for example, a low cleansing speed, an unsatisfactory effect and regular replacement caused due to likeliness to clog. Therefore, a new air purifier for decomposing smoke through water filtration is required.

### SUMMARY

An objective of the present invention is to provide an air purifier for decomposing smoke through water filtration, to resolve the foregoing technical problem.

To achieve the foregoing objective, the technical solution used in the present invention is as follows:

An air purifier for decomposing smoke through water filtration is provided, including a collection cover, an air inlet pipe, a purifier and an exhaust pipe, where the collection cover is provided with the air inlet pipe on its front top, another end of the air inlet pipe is connected with the purifier, and the purifier is connected with the collection cover through the exhaust pipe on its rear left top to form a circulating flow of air.

Based on the foregoing technical solution, the collection cover includes an acrylic shell, an air vent and an air filter element, the acrylic shell is a rectangular structure with a lower open end and is provided with two groups of symmetrically distributed air vents on its front top, and the air inlet pipe and the exhaust pipe fixed by screws are installed on a front surface of the vent hole, and the air filter element is installed on each inner side.

Based on the foregoing technical solution, the purifier includes a shell of the purifier, an air splitting box, a nozzle, a water inlet, a water outlet, a steam-water separation apparatus, a filtration apparatus, an exhaust fan, a sewage pipe, an electrode and a filtering water pipe, the air splitting box is installed on an inner side of the shell of the purifier, the air splitting box is connected with the air inlet pipe and the nozzle is installed at a top end, the water inlet is provided at a front end of the nozzle, the water outlet is provided at a right end of the air splitting box, the steam-water separation apparatus is installed at a front end of the air splitting box, the filtration apparatus is installed at a left end of the steam-water separation apparatus, the exhaust fan is installed at a bottom end of the filtration apparatus, the sewage pipe is installed at a right end of the exhaust fan, the electrode is installed on one side of the sewage pipe, and the filtering water pipe is installed on a left side of the exhaust fan.

Compared with the prior art, the present invention has the following advantages: The air purifier for decomposing smoke through water filtration in the present invention filters out and adsorbs a harmful substance in the air through a water curtain, and then purifies and decomposes the harmful substance in the water, to achieve a reuse effect, thereby reducing maintenance costs of a device and achieving a high filtration effect, without secondary pollution. Therefore, the air purifier for decomposing smoke through water filtration has a simple structure, reliable operation, and a wide application scope.

### BRIEF DESCRIPTION OF THE DRAWINGS

FIG. 1 is a schematic structural diagram of appearance of the present invention;

FIG. 2 is a schematic structural diagram of a collection cover according to the present invention; and

FIG. 3 is a schematic structural diagram of a purifier according to the present invention.

Reference signs in the drawings: 1—collection cover; 2—air inlet pipe; 3—purifier; 4—exhaust pipe; 5—acrylic shell; 6—air vent; 7—air filter element; 8—shell of the purifier; 9—air splitting box; 10—nozzle; 11—water inlet; 12—water outlet; 13—steam-water separation apparatus; 14—filtration apparatus; 15—exhaust fan; 16—sewage pipe; 17—electrode; and 18—filtering water pipe.

### DETAILED DESCRIPTION OF EMBODIMENTS

The present invention is further illustrated in detail below with reference to the accompanying drawings and embodiments.

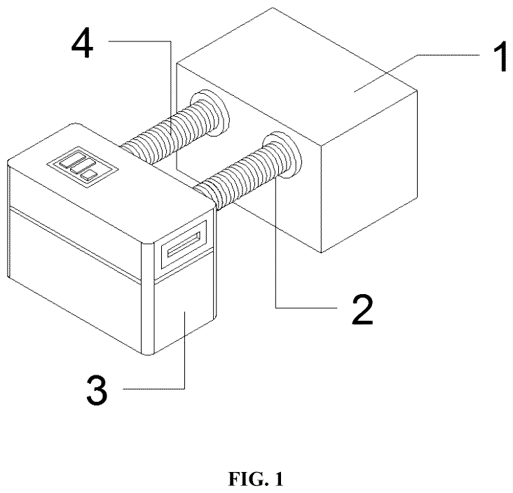

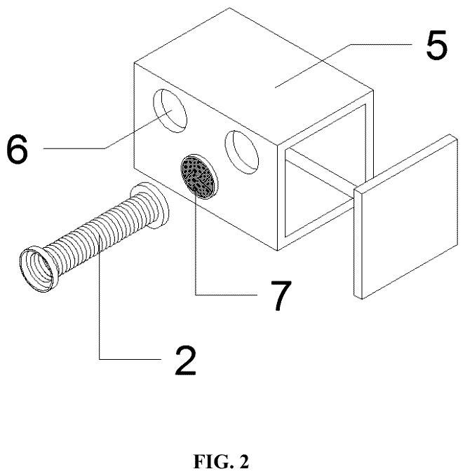

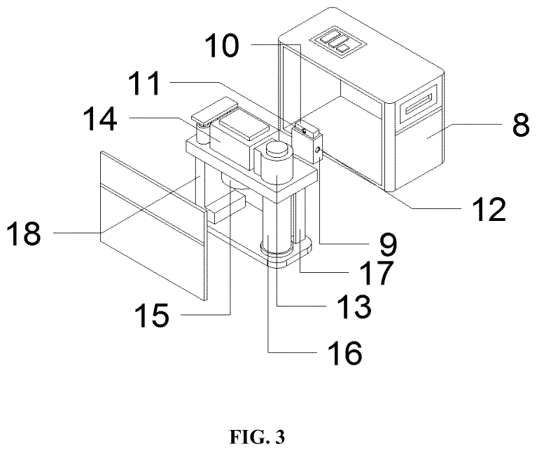

As shown in FIG. 1 to FIG. 3, an air purifier for decomposing smoke through water filtration is provided, including a collection cover 1, an air inlet pipe 2, a purifier 3 and an exhaust pipe 4, where the collection cover 1 is provided with the air inlet pipe 2 on its front top, another end of the air inlet pipe 2 is connected with the purifier 3, and the purifier 3 is connected with the collection cover 1 through the exhaust pipe 4 on its rear left top to form a circulating flow of air.

The collection cover 1 includes an acrylic shell 5, an air vent 6 and an air filter element 7, the acrylic shell 5 is a rectangular structure with a lower open end and is provided with two groups of symmetrically distributed air vents 6 on its front top, and the air inlet pipe 2 and the exhaust pipe 4 fixed by screws are installed on a front surface of the vent hole 6, and the air filter element 7 is installed on each inner side.

The purifier 3 includes a shell 8 of the purifier, an air splitting box 9, a nozzle 10, a water inlet 11, a water outlet 12, a steam-water separation apparatus 13, a filtration apparatus 14, an exhaust fan 15, a sewage pipe 16, an electrode 17 and a filtering water pipe 18, the air splitting box 9 is installed on an inner side of the shell 8 of the purifier, the air splitting box 9 is connected with the air inlet pipe 2 and the nozzle 10 is installed at a top end, the water inlet 11 is provided at a front end of the nozzle 10, the water outlet 12 is provided at a right end of the air splitting box 9, the steam-water separation apparatus 13 is installed at a front end of the air splitting box 9, the filtration apparatus 14 is installed at a left end of the steam-water separation apparatus 13, the exhaust fan 15 is installed at a bottom end of the filtration apparatus 14, the sewage pipe 16 is installed at a right end of the exhaust fan 15, the electrode 17 is installed on one side of the sewage pipe 16, and the filtering water pipe 18 is installed on a left side of the exhaust fan 15.

A working principle of the present invention is as follows: A laser cutting processing platform is first covered by the collection cover when a laser processing apparatus automatically performs processing, then a gas generated during the processing is pumped into the purifier through the air inlet pipeline, then noise is reduced with the help of a sound insulation board, and after the harmful gas enters the purifier, the harmful substance in the air is filtered out and adsorbed through the water curtain generated by the nozzle, to separate clean air from water. Water and steam in the air are separated through a group of cyclone cones, then the harmful substance is further adsorbed through a filter mesh, then clean air is pumped into the collection cover through the exhaust pipe by using the exhaust fan, and at the same time, when the polluted water for filtering out the harmful substance circulates in the sewage pipe and the filtering water channel, the harmful substance is purified and decomposed with the help of the electrode and a catalyst, to implement reuse and circulation, thereby avoiding frequent replacement of the filter element.

The preferred embodiment of the present invention is described above. For a person with ordinary skills in the art, under instruction of the present invention, changes, modifications, substitutions and variants of the embodiment made without departing from the principle and spirit of the present invention shall still fall within the protection scope of the present invention.

We claim:

1. An air purifier for decomposing smoke through water filtration, comprising a collection cover (1), an air inlet pipe (2), a purifier (3) and an exhaust pipe (4), c the collection cover (1) is provided with the air inlet pipe (2) on its front top, another end of the air inlet pipe (2) is connected with the purifier (3), and the purifier (3) is connected with the collection cover (1) through the exhaust pipe (4) on its rear left top to form a circulating flow of air.

2. The air purifier for decomposing smoke through water filtration according to claim 1, wherein the collection cover (1) comprises an acrylic shell (5), an air vent (6) and an air filter element (7), the acrylic shell (5) is a rectangular structure with a lower open end and is provided with two groups of symmetrically distributed air vents (6) on its front top, and the air inlet pipe (2) and the exhaust pipe (4) fixed by screws are installed on a front surface of the vent hole (6), and the air filter element (7) is installed on each inner side.

3. The air purifier for decomposing smoke through water filtration according to claim 1, wherein the purifier (3) comprises a shell (8) of the purifier, an air splitting box (9), a nozzle (10), a water inlet (11), a water outlet (12), a steam-water separation apparatus (13), a filtration apparatus (14), an exhaust fan (15), a sewage pipe (16), an electrode (17) and a filtering water pipe (18), the air splitting box (9) is installed on an inner side of the shell (8) of the purifier, the air splitting box (9) is connected with the air inlet pipe (2) and the nozzle (10) is installed at a top end, the water inlet (11) is provided at a front end of the nozzle (10), the water outlet (12) is provided at a right end of the air splitting box (9), the steam-water separation apparatus (13) is installed at a front end of the air splitting box (9), the filtration apparatus (14) is installed at a left end of the steam-water separation apparatus (13), the exhaust fan (15) is installed at a bottom end of the filtration apparatus (14), the sewage pipe (16) is installed at a right end of the exhaust fan (15), the electrode (17) is installed on one side of the sewage pipe (16), and the filtering water pipe (18) is installed on a left side of the exhaust fan (15).
